(19) United States
(12) Patent Application Publication
(10) Pub. No.: US 2015/0245731 A1
(43) Pub. Date: Sep. 3, 2015

(54) HEATING CIRCULATOR COOKER WITH OPENABLE PUMP HOUSING

(71) Applicant: Jeff WU, Stafford, TX (US)

(72) Inventor: Jeff WU, Stafford, TX (US)

(21) Appl. No.: 14/632,743

(22) Filed: Feb. 26, 2015

Related U.S. Application Data
(63) Continuation of application No. 61/946,431, filed on Feb. 28, 2014.

(51) Int. Cl. A47J 27/10

(52) U.S. Cl. CPC A47J 27/10

(57) ABSTRACT

A sous-vide circulator cooker temperature control device preferably suited for home cooking. The circulator cooker temperature control device includes an outer portion, an upper portion, a middle portion, and a lower portion. The upper portion includes a controller and the middle portion is connected to the upper portion, the middle portion comprises a motor coupled to the controller and a heater configured for at least partial immersion in a fluid. The lower portion is coupled to the middle portion, the lower portion having a pump mechanism. The pump mechanism can also include a housing and an impeller mechanism which can be accessed by removal of a removable cover.

### CROSS-REFERENCE TO RELATED APPLICATION

This application claims priority to U.S. Provisional Application No. 61/946,431, filed Feb. 28, 2014, the contents of which are entirely incorporated by reference herein.

### FIELD OF TECHNOLOGY

The present disclosure relates generally to food cooking devices, and more specifically, to precision temperature controlled water pump circulator appliance for cooking food in water. More particularly, this disclosure pertains to a heating circulator cooker with an openable pump housing.

### BACKGROUND

Sous-vide is a method of cooking food sealed in airtight plastic bags in a water bath for longer than normal cooking times at an accurately regulated temperature much lower than normally used for cooking, typically around 55° C. (131° F.) to 60° C. (140° F.) for meats and higher for vegetables. Current commercial sous-vide equipment are built with multiple stainless steel components that drive up fabrication costs or with integrally molded pump/casing components that while cheap to fabricate do not allow for easy cleaning as stainless steel and are not as well received by commercial kitchens when compared to stainless steel equipment.

Most attempts to create sous-vide circulators fall into these two categories with either high fabrication costs or low commercial acceptability. This novel invention marries stainless steel elements with molded plastics to create a circulator that is both cost effective to manufacture and also has the easy to clean features of stainless steel.

### BRIEF DESCRIPTION OF THE DRAWINGS

In order to describe a manner in which features of the disclosure can be obtained, reference is made to specific embodiments that are illustrated in the appended drawings. The components in the drawings are not necessarily drawn to scale, the emphasis instead being placed upon clearly illustrating the principles of the disclosure. Based on an understanding that these drawings depict only example embodiments of the disclosure and are not intended to be limiting of scope, the principles herein are described and explained with additional specificity and detail through the use of the accompanying drawings. Moreover, in the drawings, like reference numerals designate corresponding parts throughout the several views.

FIG. 1 is a side view of an embodiment of a heat circulator cooker in accordance with a first exemplary embodiment.

FIG. 2 is an isometric view of a heat circulator cooker with an outside shell and showing an exploded view of the pump base in accordance with a second exemplary embodiment.

FIG. 3 is an isometric view of a heat circulator cooker with an outside shell and showing the pump base in accordance with a second exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” A person skilled in the relevant art will recognize that other components and configurations may be used without departing from the scope of the disclosure.

Several definitions that apply throughout this document will now be presented. “Circulating” means agitating, blending or mixing of one or more fluids. Hence a “circulator” is a device which can be configured to agitate, blend or mix a fluid. Fluids will be understood to comprise liquids. “Coupled” is defined as connected, whether directly or indirectly through intervening components and is not necessarily limited to physical connections. Coupled devices are devices which are in signal communication with one another. “Connected” means directly connected or indirectly connected. Broadly speaking, this disclosure relates to cooking apparatus for food preparation. More specifically, this disclosure relates to sous-vide circulator cookers. This application refers to a sous vide circulator cooker, heat circulator cooker, and circulator cooker interchangeably.

Broadly speaking, this disclosure relates to cooking apparatus for food preparation. More specifically, this disclosure relates to sous vide circulator cookers. This application refers to a sous vide circulator cooker, heat circulator cooker, and circulator cooker interchangeably.

A circulator cooker temperature control device having an upper portion, a middle portion, and a lower portion. The upper portion can include a controller. The controller can be coupled to a display device and an input device. The middle portion and lower portion can be housing within an outer portion. The outer portion can be a protective shell capable of securing the circulator. The outer portion can include at least one opening. The at least one opening can allow the cooking fluid to circulate into and out of the outer portion. In at least one embodiment, the outer portion can house the middle and lower portion. In another embodiment, the outer portion can house the upper, middle, and lower portions. In yet another embodiment, the outer portion can house the lower portion. The middle portion can be connected to the upper portion and include a motor coupled to the controller and a heater configured for at least partial immersion in a fluid. The middle portion can also include a thermometer and a water level sensor. The lower portion can be coupled to the middle portion and have a pump mechanism. The pump mechanism can include an impeller contained within a housing that can be opened by a removable cover. The removable cover can be a sliding pane, a hinged door, or a screw cap arrangement. In at least one embodiment, the removable cover includes at least one opening. The circulator cooker temperature control device can also include an integrated clamp capable of securing the protective shell to the circulator. The circulator cooker temperature control device of claim 1, wherein the outer portion further comprises an enclosure wherein the enclosure has a plurality of indentations to allow preset fluid immersion depths to be made for easier placement into fluid.

In at least one embodiment, a sous vide circulator cooker can have an outer portion, an upper portion, a middle portion coupled to the upper portion, and a lower portion coupled to the middle portion. The upper portion can have a controller, display device, and an input device.

The upper portion can be configured to protect the controller, display device, and input device from steam during use. The middle portion can include a motor coupled to the controller, and a steam removal fan coupled to the motor. The lower portion can include a fluid agitation device coupled to the motor, a heating element coupled to the controller, and the lower portion configured for at least partial immersion in at least one fluid. The fluid agitation device can be an impeller or a rotatable blade. The fluid agitation device can be housed within a pump mechanism. The pump mechanism can include a pump base, and an impeller. The pump base can be designed to surround the impeller.

In at least one embodiment, a heat circulator cooker includes a pump mechanism that can be opened and cleaned. Specifically, the pump mechanism can include a housing, a fluid agitation device, and a removable cover coupled to the housing. The removable cover can be a sliding pane, a hinged door with a securing mechanism, a screw cap mechanism, or any other mechanism. The removable cover is configured to be coupled and decoupled from the housing without the use of tools. Once the removable cover has been removed from the housing, the fluid agitation device is exposed. The fluid agitation device can be cleaned to remove any foreign particulate, specifically any particulate associated with food preparation. The pump mechanism including the housing, the fluid agitation device, and removable cover can be fabricated from stainless steel, molded from plastic, or any other material suitable for food preparation.

In at least one embodiment, a portion of a sous-vide circulator cooker can be enabled to be easily removed from an outer portion. The outer portion can be a protective shell. The protective shell can be stainless steel, or any like material acceptable for food preparation. The protective shell can be removed for cleaning purposes, allowing easy access to internal components. The outer portion can be capable of encompassing the circulator cooker, thus containing the elements of the circulator cooker. The outer shell can also be configured to interact with a clamping mechanism capable of securing the outer shell to the circulator cooker.

In at least one embodiment, a sous-vide cooker can include an outer portion that can be removed without tools. The sous-vide cooker can also include a removable pump base cover that can be removed without tools.

In at least one embodiment, a heat circulator cooker includes a Wi-Fi or Bluetooth radio for recipe specification uploads from phone, tablet, or PC and direct remote control and monitoring. Thus, at least one embodiment of this disclosure a fluidic temperature controller can include a non-volatile memory that stores a plurality of recipe specifications and user generated data files as well as a control interface that enables a user of the heat circulator cooker to select and recall recipe specifications. In at least one embodiment of this disclosure, a heat circulator cooker can search for recipes that match certain specification criteria.

In at least one embodiment, a heat circulator cooker can include a rotatable head controller portion. Storing most microelectronics within such a rotatable structure enables the microelectronics to be located away from the steam source. An interface on the head controller can also be turnable to enable user to adjust a viewing angle.

In another embodiment, a system interface has dynamically color changing icons, objects, or backgrounds to notify operator of system temperature and tank water level. Additionally, the controller may contain a speaker to sound music alarms and reminders.

In some embodiments, the upper portion of the fluidic temperature control is configured to protect the controller, display device, and input device from steam during use.

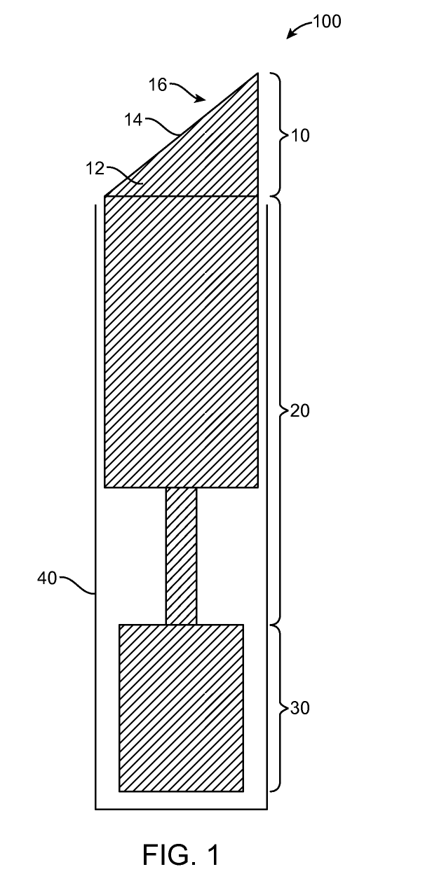

FIG. 1 illustrates a side view of a heat circulator cooker in accordance with a first exemplary embodiment. As discussed above, the device 100 includes an outer portion 40, an upper portion 10, a middle portion 20, and a lower portion 30. The outer portion 40 can be a protective shell capable of encompassing and coupling to the circulator cooker 100. In at least one embodiment, the outer portion 40 can be a mesh configured to protect components but still allow fluid circulation. The outer portion 40 can be coupled to the circulator cooker via an integrated clamp, clipping mechanism or other quick release mechanism. The quick release mechanism can allow the outer shell to be removed without the use of tools. The integrated clamping mechanism can also secure the outer portion 40 in place, thereby housing the internal components during use. The housing can also enclose and support various internal electronic components (including motors, fans, and electronics). The housing shape can also vary in appearance depending on design of the heat circulator cooker. The upper portion 10 can include a controller 12, a display device 14, and an input device 16 coupled to the controller. The display device 14 can display information such as the temperature of the cooking fluid in which the lower portion is at least partially immersed or the speed at which an impeller housed within the lower portion is spinning. The input device 16 can include one or more buttons or controls which can enable a user to select a temperature for the cooking fluid in which the lower portion is at least partially immersed.

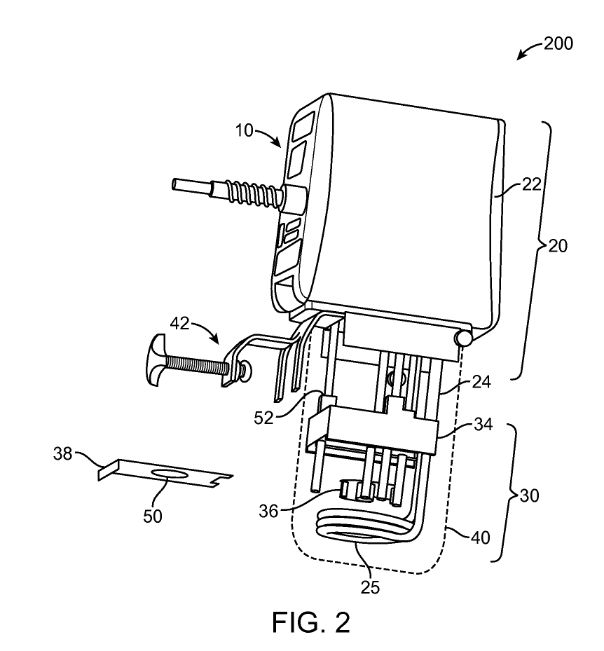

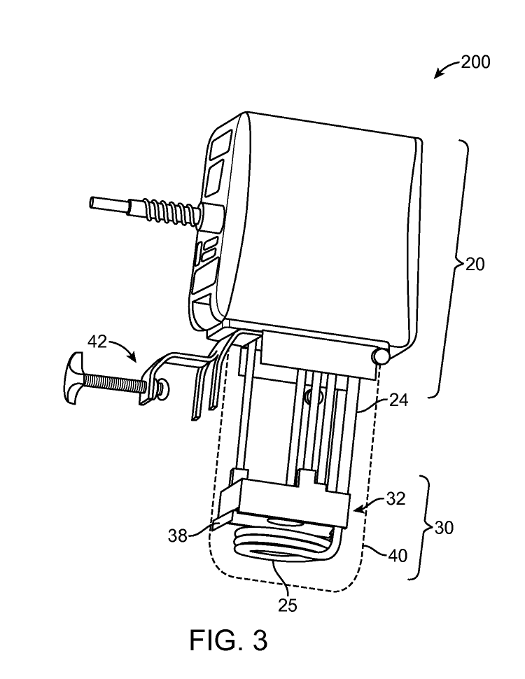

FIGS. 2 and 3 illustrate isometric views of a heat circulator cooker in accordance with a second exemplary embodiment. In the illustrated embodiment, the upper portion 10 and middle portion 20 can be substantially adjacent to one another. The middle portion 20 can include a motor 22 coupled to the controller and heater 24. The heater 24 can include heating coils 25. The heating coils 25 can be configured for at least partial immersion in a fluid. The lower portion 30 can include a pump mechanism 32 wherein the pump mechanism can include a housing 34 with a removable cover 38. The removable cover 38 can be coupled to the housing 34 with a sliding pane, a hinged door, a screw cap, or another suitable mechanism capable of being removed without tools. The housing 34 encompasses the impeller mechanism 36, and when the removable cover 38 is properly attached the housing 34 and removable cover 38 encase the impeller mechanism 36. FIG. 2 illustrates the removable cover 38 detached from the housing 34, thus exposing the impeller mechanism 36. FIG. 3 illustrates the pump mechanism 32 with the removable cover 38 attached, thus completely encasing the impeller mechanism 36. The housing and removable cover 38 can include a plurality of openings 50 for the intake and expulsion of the fluid as the impeller agitates the fluid. These openings 50 can be located on any surface of the housing 34 or removable cover 38 depending on the design of the impeller mechanism 36. The plurality of openings can allow the impeller mechanism 36 to generate a pressure differential within the impelling housing 34. The pressure differential generated by the impeller mechanism 36 can cause fluid circulation of the cooking fluid.

It is believed the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiments of the disclosure.

1. A circulator cooker temperature control device comprising:
an upper portion including a controller; and
an outer portion containing a middle portion and a lower portion, the middle portion connected to the upper portion, the middle portion comprising a motor coupled to the controller and coupled to a heater configured for at least partial immersion in a fluid;
wherein the lower portion is coupled to the middle portion, the lower portion having a pump mechanism, the pump mechanism further compromising a housing and an impeller mechanism that can be opened by a removable cover.

2. The circulator cooker temperature control device of claim 1, wherein the upper portion further comprises a display device and an input device coupled to the controller.

3. The circulator cooker temperature control device of claim 1, wherein the middle portion further comprises a thermometer, and a water level sensor.

4. The circulator cooker temperature control device of claim 1 wherein the removable cover is selected from a group consisting of a sliding pane, a hinged door, and a screw cap.

5. The circulator cooker temperature control device of claim 1, wherein the outer portion is a protective shell capable of securing the circulator;

6. The circulator cooker temperature control device of claim 5 further comprising an integrated clamp capable of securing the protective shell to the circulator.

7. The circulator cooker temperature control device of claim 1, wherein the outer portion further comprises an enclosure wherein the enclosure has a plurality of indentations to allow preset fluid immersion depths to be made for easier placement into fluid.

8. The circulator cooker temperature control device of claim 1 wherein the removable cover includes at least one opening.

9. The circulator cooker temperature control device of claim 1 wherein the outer portion includes at least one opening.
